(19) United States
(12) Patent Application Publication
(10) Pub. No.: US 2014/0156831 A1
(43) Pub. Date: Jun. 5, 2014

(54) APPARATUS AND METHOD FOR MONITORING SIGNALS TRANSMITTED IN BUS

(71) Applicants: HON HAI PRECISION INDUSTRY CO., LTD., New Taipei (TW); HONG FU JIN PRECISION INDUSTRY (ShenZhen) Co., Ltd, ShenZhen (CN)

(72) Inventor: KANG-BIN WANG, Shenzhen (CN)

(21) Appl. No.: 13/945,107

(22) Filed: Jul. 18, 2013

(30) Foreign Application Priority Data
Dec. 4, 2012 (CN) 2012105110278

(51) Int. Cl. H04L 12/26

(52) U.S. Cl. CPC H04L 43/10
USPC 709/224

(57) ABSTRACT

A signal monitor includes a signal collecting unit, a register, a processing unit, and a Reduced Media Independent Interface (RMII). The signal collecting unit collects real-time signals from a bus, converts the real-time signals into accessible data, and stores the accessible data in the register. The processing unit retrieves the accessible data from the register and determines status of the real-time signals by examining the accessible data. The RMII converts the status of the real-time signals into Ethernet frame packets and transmits the Ethernet frame packets to a control terminal via an Ethernet interface. A method for monitoring signals transmitted in a bus is also provided.

### REFERENCE TO RELATED APPLICATIONS

This application claims all benefits accruing under 35 U.S.C. § 119 from China Patent Application No. 201210511027.8, filed on Dec. 4, 2012 in the State Intellectual Property Office of China. The contents of the China Application are hereby incorporated by reference. In addition, subject matter relevant to this application is disclosed in: co-pending U.S. Patent Application entitled “APPARATUS AND METHOD FOR MONITORING SIGNALS TRANSMITTED IN BUS,” Attorney Docket Number US48033, Application No. [to be advised], filed on the same day as the present application. This application and the co-pending U.S. Patent Applications are commonly owned, and the contents of the co-pending U.S. Patent Applications are hereby incorporated by reference.

### BACKGROUND

1. Technical Field

The disclosure generally relates to data communication, and particularly relates to apparatuses and methods for monitoring real-time signals transmitted in a bus.

2. Description of Related Art

For serial data communication between multiple devices, the Inter-Integrated Circuit (I2C) bus and the Serial Peripheral Interface (SPI) bus have been developed and widely accepted in the consumer electronics, telecommunications and industrial electronics fields. However, it is difficult to acquiring the status of real-time signals transmitted in the I2C bus or the SPI bus.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a data communication system equipped with a signal monitor.

FIG. 2 is a block diagram of one embodiment of a signal monitor.

FIG. 3 is a block diagram of one embodiment of a control terminal

FIGS. 4 and 5 show a flowchart of one embodiment of a method for monitoring real-time signals transmitted in a bus.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

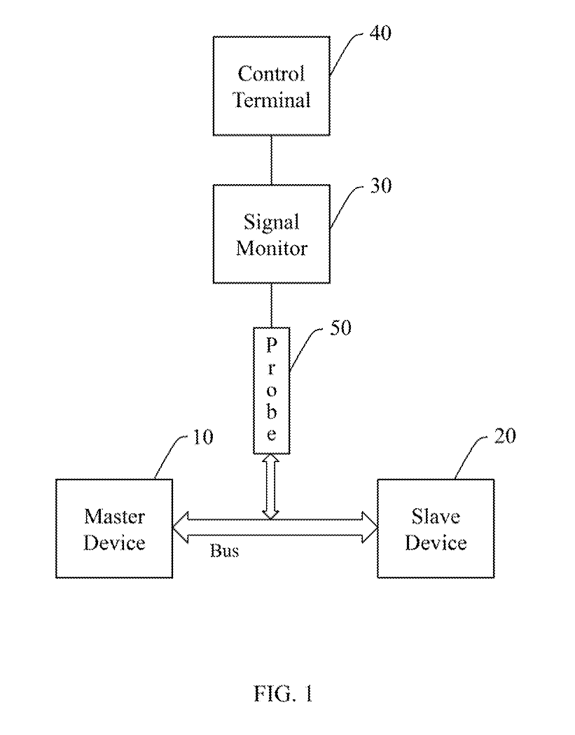

FIG. 1 shows one embodiment of a data communication system. The data communication system includes a master device 10, a slave device 20, a signal monitor 30, a control terminal 40, and a signal probe 50.

The master device 10 is connected to the slave device 20 via a bus, for example, an I2C bus or a SPI bus. An I2C bus includes a Serial Data (SDA) line and a Serial Clock (SCL) line. A SPI bus includes a Master-Out-Slave-In (MOSI) line, a Master-In-Slave-Out (MISO) line, a Serial Clock (SCL) line, and a Slave Select (SS) line. The master device 10 and the slave device can transmit data to each other via the bus.

The signal probe 50 is electrically connected to the bus that interconnects the master device 10 the slave device 20. The signal monitor 30 is connected to the bus through the signal probe 50. The signal monitor 30 collects real-time signals transmitted in the bus through the signal probe 50. In some embodiments, the signal probe 50 includes a unidirectional transmission module (not shown) which prevents any signal from being transmitted from the signal monitor 30 to the bus. Thus, the signal monitor 50 is prevented from damaging signals transmitted in the bus.

When the signal monitor 30 collects the real-time signals transmitted in the bus, the signal monitor 30 can examine the real-time signals and report the status of the real-time signals to the control terminal 40.

The control terminal 10 provides a user interface for displaying the status of the real-time signals transmitted in the bus. The control terminal 10 may be a personal computer, a server computer, a tablet computer, or the like.

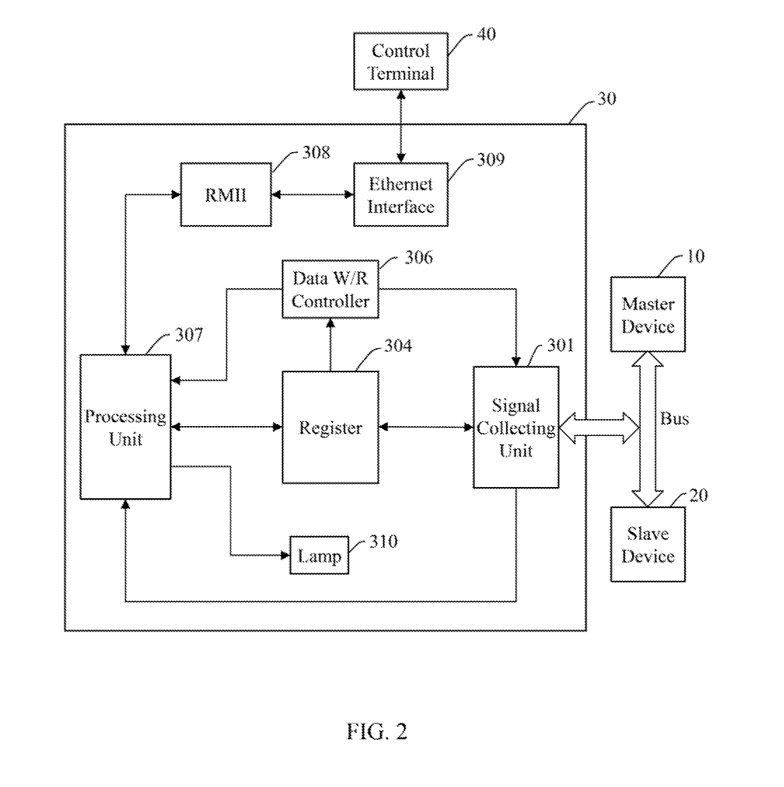

FIG. 2 shows one embodiment of the signal monitor 30. The signal monitor 30 includes a signal collection unit 301, a register 304, a data write/read (W/R) controller 306, a processing unit 307, a Reduced Media Independent Interface (RMII) 308, an Ethernet interface 309, and an indicating lamp 310.

The signal collecting unit 301 collects the real-time signals transmitted in the bus through the signal probe 50 and converts the collected real-time signals into accessible data according the protocol of the bus, for example, the I2C bus protocol or the SPI bus protocol.

The signal connecting unit 301 stores the accessible data in the register 304. In some embodiments, the register 304 is a First Input First Output (FIFO) register. Thus, the accessible data which is firstly stored in the register 304 can be firstly read from the register 304.

When the register 304 is full, the register 304 sends an out-of-space signal to the data W/R controller 306. In response to the out-of-space signal from the register 304, the data W/R controller 306 sets the register 304 to a write-protected state and informs the signal collecting unit 301 and the processing unit 307 that the register 304 is full. The processing unit 307 starts reading accessible data from the register 304. When the processing unit 307 has finished reading the accessible data from the register 304, the data W/R controller 306 sets the register 304 to a write-permitted state.

When the register 304 is in the write-protected state, the signal collecting unit 301 suspends collecting real-time signals from the bus. When the register 305 is set to the write-permitted state, the signal collecting unit 301 continues to collect real-time signals from the bus and stores the subsequent accessible data in the register 304.

When the register 304 is empty, the processing unit 307 enters a standby state and suspends reading data from the register 304. When the processing unit 307 receives an out-of-space signal from the register, the processing unit 307 exits the standby state.

When the processing unit 307 receives the accessible data from the register 304, the processing unit 307 determines status of the real-time signals transmitted in the bus by examining the accessible data. The processing unit 307 then transmits the status of the real-time signals to the RMII 308.

The RMII 308 converts the status of the real-time signals into Ethernet frame packets and transmits the Ethernet frame packets to the Ethernet interface 309.

The Ethernet interface 309 establishes an Ethernet connection with the control terminal 40 and transmits the status of the real-time signals to the control terminal 40 via the Ethernet connection.

The indicating lamp 310 indicates the working status of the signal monitor 30. While the processing unit 307 is examining the accessible data, the processing unit 307 controls the indicating lamp 310 to flicker.

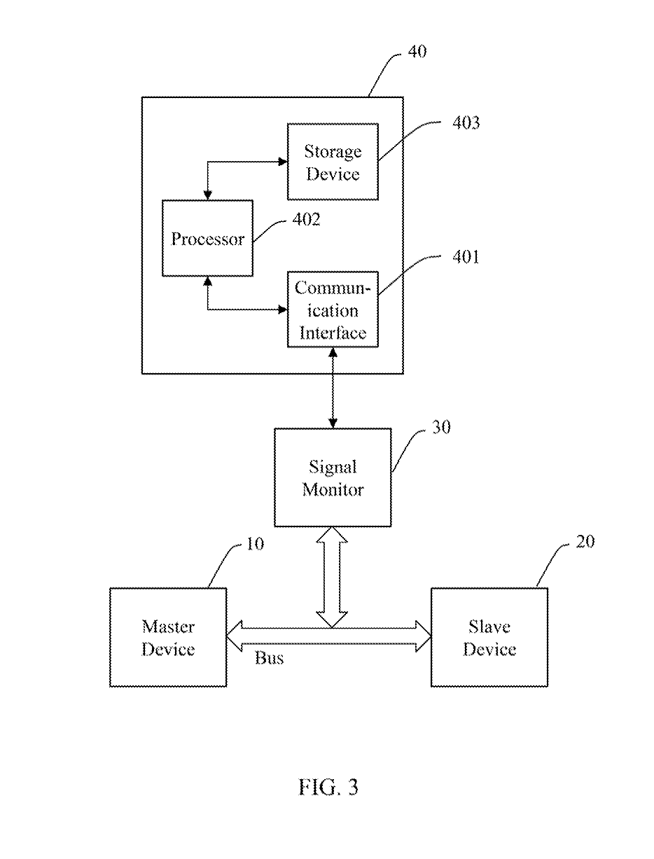

FIG. 3 shows one embodiment of the control terminal 40. The control terminal 40 includes a communication interface 401, a processor 402 and a storage device 403.

The communication interface 401 establishes an Ethernet connection with the Ethernet interface 309 of the signal monitor 30 and receives the Ethernet frame packets from the signal monitor 30 via the Ethernet connection. The communication interface 401 transmits the Ethernet frame packets to the processor 402. The processor 402 obtains the status of the real-time signals from the received Ethernet frame packets and stores the status of the real-time signals in the storage device 403.

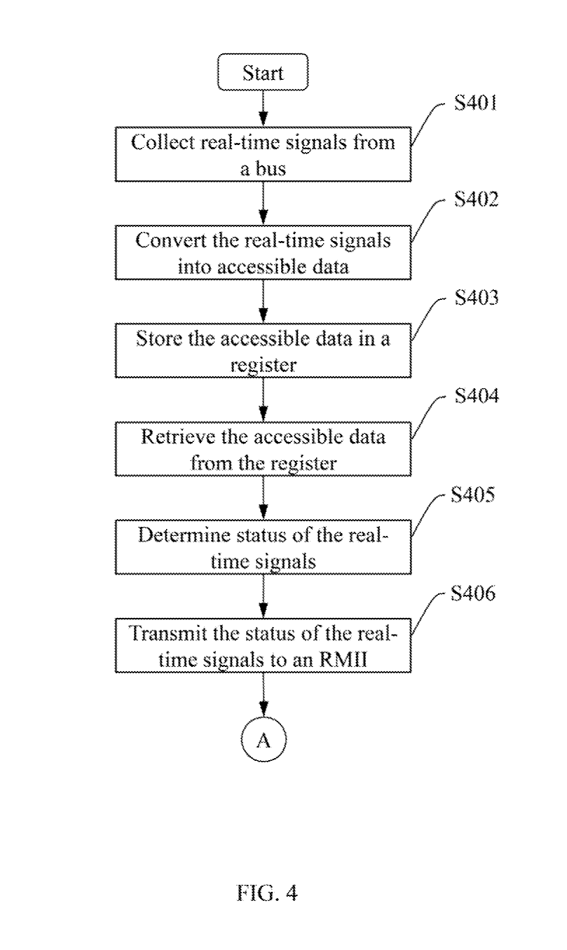

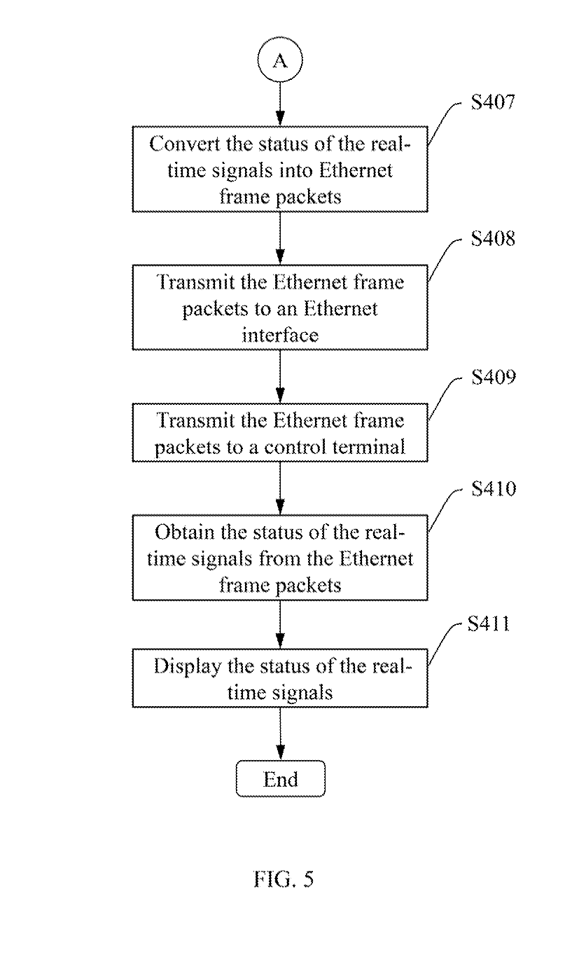

FIGS. 4 and 5 show a flowchart of one embodiment of a method for monitoring real-time signals transmitted in a bus. The method includes the following steps.

In step S401, the signal collecting unit 301 collects real-time signals from a bus through the signal probe 50.

In step S402, the signal collecting unit 301 converts the real-time signals into accessible data according to the protocol of the bus.

In step S403, the signal collecting unit 301 stores the accessible data in the register 304.

In step S404, the processing unit 307 reads the accessible data from the register 304.

In step S405, the processing unit 307 determines status of the real-time signals transmitted in the bus by examining the accessible data.

In step S406, the processing unit 307 transmits the status of the real-time signals to the RMII 308.

In step S407, the RMII 308 converts the status of the real-time signals into Ethernet frame packets.

In step S408, the RMII 308 transmits the Ethernet frame packets to the Ethernet interface 309.

In step S409, the Ethernet interface 309 establishes an Ethernet connection with the control terminal 40 and transmits the Ethernet frame packets to the control terminal 40 via the Ethernet connection.

In step S410, the control terminal 10 obtains the status of the real-time signals from the received Ethernet frame packets.

In step S411, the control terminal 10 provides a user interface for displaying the status of the real-time signals.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A signal monitor, comprising:
a signal collecting unit adapted to collect real-time signals from a bus, to convert the real-time signals into accessible data;
a register adapted to store the accessible data;
a processing unit adapted to retrieve the accessible data from the register, and to determine status of the real-time signals by examining the accessible data;
a Reduced Media Independent Interface (RMII) adapted to convert the status of the status of the real-time signals into Ethernet frame packets; and
an Ethernet interface adapted to transmit the Ethernet frame packets to a control terminal

2. The signal monitor of claim 1, further comprising a data Write/Read (W/R) controller adapted to set the register to a write-protected state when the register is full.

3. The signal monitor of claim 2, wherein the register is adapted to send an out-of-space signal to the data W/R controller when the register is full.

4. The signal monitor of claim 2, wherein the signal collecting unit is adapted to suspend collecting the real-time signals from the bus when the register is in the write-protected state.

5. The signal monitor of claim 2, wherein the data W/R controller is further adapted to set the register to a write-permitted state when the processing unit has finished reading the accessible data from the register.

6. The signal monitor of claim 3, wherein the register is further adapted to send an out-of-space signal to the processing unit when the register is full, the processing unit is adapted to start reading the accessible data from the register in response to the out-of-space signal.

7. The signal monitor of claim 6, wherein the processing unit is adapted to enter a standby state when the register is empty and to exit the standby state when receiving the out-of-space signal.

8. The signal monitor of claim 1, wherein the register is a First Input First Output (FIFO) register.

9. The signal monitor of claim 1, further comprising an indicating lamp adapted to flicker while the processing unit is examining the accessible data.

10. The signal monitor of claim 1, wherein the Ethernet interface is adapted to establish an Ethernet connection with the control terminal and to transmit the Ethernet frame packets to the control terminal via the wireless connection.

11. A method for monitoring signals transmitted in a bus, the method comprising:
collecting real-time signals from a bus and converting the real-time signals into accessible data by a signal collecting unit;
storing the accessible data in a register by the signal collecting unit;
retrieving the accessible data from the register and determining status of the real-time signals by examining the accessible data by a processing unit;
converting the status of the status of the real-time signals into Ethernet frame packets by an RMII; and
transmitting the Ethernet frame packets to a control terminal by an Ethernet interface.

12. The method of claim 11, further comprising setting the register to a write-protected state by a data W/R controller when the register is full.

13. The method of claim 12, further comprising sending an out-of-space signal to the data W/R controller by the register when the register is full.

14. The method of claim 12, further comprising suspending collecting the real-time signals from the bus when the register is in the write-protected state.

15. The method of claim 12, further comprising setting the register to a write-permitted state by the data W/R controller when the processing unit has finished reading the accessible data from the register.

16. The method of claim 13, further comprising sending an out-of-space signal to the processing unit by the register when the register is full, wherein the processing unit starts reading the accessible data from the register in response to the out-of-space signal

17. The method of claim 16, further comprising:
instructing the processing unit to enter a standby state when the register is empty; and
instructing the processing unit to exit the standby state when the processing unit receives the out-of-space signal from the register.

18. The method of claim 11, wherein the register is an FIFO register.

19. The method of claim 11, further comprising controlling an indicating lamp to flicker while the processing unit is examining the accessible data.

20. The method of claim 11, further comprising establishing an Ethernet connection with the control terminal and transmitting the Ethernet frame packets to the control terminal via the Ethernet connection by the Ethernet interface.
